(19) United States
(12) Patent Application Publication
(10) Pub. No.: US 2018/0252520 A1
(43) Pub. Date: Sep. 6, 2018

(54) METHOD FOR CORRECTING COORDINATE MEASUREMENT MACHINE ERRORS

(71) Applicant: Nikon Metrology NV, Leuven (BE)

(72) Inventor: Christopher Stott, Derby (GB)

(21) Appl. No.: 15/561,106

(22) PCT Filed: Mar. 24, 2016
(86) PCT No.: PCT/EP2016/056623

§ 371 Date: Sep. 25, 2017

(30) Foreign Application Priority Data
Mar. 26, 2015 (EP) 15161009.4

(51) Int. Cl. G01B 21/04; G01B 9/02; G01B 11/00

(52) U.S. Cl. CPC G01B 21/045; G01B 11/005; G01B 9/02063; G01B 21/047

(57) ABSTRACT

The invention provides a method for creating or refining a mathematical correction model for correcting dynamic measurement errors in a co-ordinate measurement machine having at least 3 linear machine axes X, Y, and Z, each comprising a machine linear scale, and provided with a measurement probe. An error model for considering acceleration errors is created and refined using actual measurements of the probe position when accelerating. Also the probe offset from the linear translation axes is considered.

### FIELD OF THE INVENTION

The present invention relates to coordinate measuring machines, and to methods correcting errors of dimensional measurements using a co-ordinate measurement machine.

### BACKGROUND OF THE INVENTION

A coordinate measuring machine (or CMM) is a device for measuring the physical geometrical characteristics of an object. This machine may be manually controlled by an operator or it may be computer controlled. Measurements are typically obtained through a measurement probe attached to the third moving axis of such a machine. Measurement probes may be mechanical or optical, based on lasers or white light, among others. The typical “3 bridge CMM” or bridge CMM is composed of three axes: X, Y, and Z. These axes are typically orthogonal to each other in a typical three dimensional coordinate system. Each axis usually has a linear scale system that indicates the location of the measurement probe along that axis, which may be read off on a read-off point. The machine will read the output from the measurement probe, as directed by an operator or programmer. The machine then uses the X, Y, Z coordinates of each of these points to determine size and position with typically up to micrometre precision. A coordinate measuring machine is often used in manufacturing and assembly processes to test a part or assembly against the design intent. By precisely recording the X, Y, and Z coordinates of the target, points are generated which can then be analyzed via mathematical methods, such as regression algorithms, for the construction of features, such as a hole, and edge, a slot, a boss, a protrusion, a hole pattern, etc.

The CMM is preferably built from stiff materials in order to have repeatable and dependable behaviour. Air bearings may act as a spring with a varying air gap size for overcoming normal static forces such as gravity or friction. The acceleration of machine parts to drive the machine motion will also generate varying forces on the air bearings. In addition, the driving force vector does not intersect with the centre of mass of the driven object, and will therefore cause a rotational acceleration, which will cause both a rotation and a deformation of the CMM axis which will be visible as a position error between the actual probe position (actual probe position) and the scale reader head position (apparent probe position). The rotational acceleration will cause the machine axis to show a combination of a rigid body rotation and a deformation. As a result, the machine parts may start to oscillate and the linear scales, located at one end of the machine part, will no longer be accurately representative for the position of the measurement probe, when determined for example by a CMM sensor. Due to the offset between the driving position of the coordinate measurement machine and the centre of mass, the rigid body of the coordinate measurement machine will undergo both deformational and rotational forces, inducing errors.

The swinging motion can be accounted for along the linear scales, i.e. the scale measurement will be subject to the oscillation and will automatically correct for it. However, as one moves away from the scale to the measurement probe, additional errors occur which are not accounted for. This distance from scale to measurement probe comprises a static offset and a traverse position provided by the linear scales themselves. The offset OY for Y axis correction is typically in the Z-direction, i.e. OY(Z), as illustrated in FIGS. 1 and 11. The offset OX for the X axis correction typically has two components OX(Y) and OX(Z). 3-axis CMMs commonly suffer from these additional errors, due to the offset between the driving and position sensing side and the ever changing centre of gravity of the moving structure. As a consequence, the actual position of the measurement probe (and more specifically the probe head or tip) is not reflected by the linear scale readings due to acceleration/deceleration and the flexibility of the structure, not even after taking static corrections into account.

Several methods are known to minimize or compensate for this type of position error on CMMs. However, these are often quite costly, still prone to errors, approximate, slow, and/or valid for only a small sub-space of the complete 3-dimensional workspace.

Therefore, there is a need for new models, methods and systems that allow correction of the errors induced by acceleration/deceleration of the coordinate measurement machine and by the flexibility of the structure.

### SOME EMBODIMENTS OF THE INVENTION

The models, methods, and systems of the present invention, and preferred embodiments thereof, allow prediction and compensation for the dynamic behaviour of linear CMM axes, based on the reading of linear scales and a mathematical correction model of the CMM structure, thereby overcoming one or more of the aforementioned problems.

Acceleration of the coordinate measurement machine (100) along one of the X, Y or Z axes (on the driving side) is preferably deduced from the continuous reading of the linear scales (on the measuring side) (e.g. second derivative over time). An apparent position of the measurement probe (110) is preferably deduced from the continuous reading of the linear scales, and an actual position of the measurement probe (110) is preferably deduced using a non-contact measurement system (111). The apparent position of the measurement probe (110) requires correction, owing to the dynamic behaviours of the CMM (or parts thereof), in particular of the axes as described above, and due to the driving action of the coordinate measurement machine (100) not coinciding with the centre of mass resulting in a rotational acceleration, which results in both rotation and deformation of the structure. A model for the dynamic behaviour of the CMM is then defined, taking into account the measured accelerations, actual and apparent measurement probe (110) positions, but optionally also CMM mass, flexibility, and position. From these parameters, the model may continuously estimate the positional deviation, also known as the dynamic accuracy of a CMM. As a result, the CMM will be more accurate during slow and fast motion, which is particularly interesting for both tactile probing at lower speed, and laser scanning at higher speed.

A first aspect of the invention provides a method for creating or refining a mathematical correction model for correcting measurement errors in a co-ordinate measurement machine (100) having at least 3 linear machine axes (102, 104, 106), each comprising a machine linear scale (102′, 104′, 106′), and provided with a measurement probe (110). The method comprises accelerating the co-ordinate measurement machine (100) along one of the linear machine axes, for example by accelerating the measurement probe (110) and at least one of the 3 linear machine axes X, Y, and Z (102, 104, 106) of the co-ordinate measurement machine (100) along one of the linear machine axes (102, 104, 106), and creating or refining the mathematical correction model using apparent measurement probe (110) position and actual measurement probe (110) position and the measurement probe (110) acceleration at said apparent position.

The invention also provides a method for creating or refining a mathematical correction model for correcting measurement errors in a co-ordinate measurement machine (100) having at least 3 linear machine axes (102, 104, 106), each comprising a machine linear scale (102′, 104′, 106′), and provided with a measurement probe (110), comprising the steps:
(i) accelerating the co-ordinate measurement machine (100) along one of the linear machine axes (102, 106, 106), for example by accelerating the measurement probe (110) and at least one of the 3 linear machine axes X, Y, and Z (102, 104, 106) of the co-ordinate measurement machine (100) along one of the linear machine axes (102, 104, 106)
(ii) measuring the apparent position of the measurement probe (110) using the machine linear scale (102′, 104′, 106′) and synchronously measuring the actual position of the measurement probe (110); preferably wherein the actual position of the measurement probe (110) is deduced using a non-contact measurement system (111);
(iii) calculating measurement errors as a function of measurement probe (110) acceleration and apparent and actual measurement probe (110) positions;
(iv) repeating steps (i) to (iii) for different measurement probe (110) positions and/or accelerations; and
(v) creating or refining a mathematical correction model using the measurement errors at different measurement probe (110) positions and accelerations.

More specifically, the invention provides a method for creating or refining a mathematical correction model for predicting a general measurement error E depending on general input variables position P and acceleration A of dimensional measurements obtained from a co-ordinate measurement machine (100) comprising 3 linear machine axes X, Y, and Z and provided with a measurement probe (110) for the dimensional measurement of an object (200). Preferably, the method comprises the steps of:
(i) accelerating the co-ordinate measurement machine (100) along an axis selected from X, Y, or Z, for example by accelerating the measurement probe (110) and at least one of the 3 linear machine axes X, Y, and Z (102, 104, 106) of the co-ordinate measurement machine (100) along one of the linear machine axes (102, 104, 106);
(ii) performing a non-contact measurement of the actual position Pa(m) of the measurement probe (110) for one or more apparent positions Pr(m) using the measurement probe (110) moved at one or more different accelerations A(n) at one or more different positions Pr(m);
(iii) calculating a dimensional measurement error E(mn) for each acceleration A(n) of the measurement probe (110) at each position Pr(m) based on Pa(m) and Pr(m);
(iv) repeating the procedure; for different measurement probe (110) positions and/or accelerations; and
(v) creating or refining a mathematical correction model for predicting a general measurement error E depending on general input variables position P and acceleration A, which mathematical correction model is derived from E(mn), Pr(m) and A(n).

This method is generic and independent of the object to be measured, and it has the additional advantages that it covers the complete 3D measurement volume, since it is not limited to the volume occupied by a measurement artefact, such as a ring gauge. Furthermore, the measurements can be made quickly and the model can be obtained at a reasonable cost. In some preferred embodiments, the method is performed without a reference object.

In some preferred embodiments, the actual position measurement, for example in step (ii), is a dynamic laser measurement, preferably using a non-contact measurement system (111), for example a laser interferometer or a laser distance sensor.

In some preferred embodiments, the apparent positions Pr(m) defined by the X, Y, and Z axes are obtained via linear scale readings of the axes X, Y, and/or Z. In some preferred embodiments, the acceleration variables A(n) are calculated as the second derivative over time of the position variables Pr(m), from the prior variation over time of the position of the measurement probe (110) or the coordinate measurement machine (100). In some preferred embodiments, the 3 linear machine axes X, Y, and Z are essentially straight and essentially perpendicular with respect to each other. In some preferred embodiments, the mathematical correction model utilises one or more mechanical properties of the co-ordinate measurement machine (100), or parts thereof, and/or the centre of mass of the co-ordinate measurement machine, or parts thereof. In some preferred embodiments, mechanical properties comprise the stiffness and/or the mass, for example wherein the co-ordinate measurement machine comprises air bearings.

In some preferred embodiments, the mathematical correction model is refined by repeating the acceleration of the coordinate measurement machine (100), for example the acceleration of the measurement probe (110) and at least one of the 3 linear machine axes X, Y, and Z (102, 104, 106) of the co-ordinate measurement machine (100) along one of the linear machine axes (102, 104, 106), wherein:
the acceleration of the coordinate measurement machine (100), for example the acceleration of the measurement probe (110) and at least one of the 3 linear machine axes X, Y, and Z (102, 104, 106) of the co-ordinate measurement machine (100), is along a different linear axis;
the coordinate measurement machine (100) is fixed in one or both of the other two axes at a different position during acceleration of the coordinate measurement machine (100), for example during the acceleration of the measurement probe (110) and at least one of the 3 linear machine axes X, Y, and Z (102, 104, 106) of the co-ordinate measurement machine (100);
the magnitude of the acceleration of the coordinate measurement machine (100) is different, for example the magnitude of the acceleration of the measurement probe (110) and at least one of the 3 linear machine axes X, Y, and Z (102, 104, 106) of the co-ordinate measurement machine (100) is different;
the position of the acceleration of the coordinate measurement machine (100) along the axis is different, for example the position of the acceleration of the measurement probe (110) and at least one of the 3 linear machine axes X, Y, and Z (102, 104, 106) of the co-ordinate measurement machine (100) is different; or
a combination of two or more of the above.

In a second aspect, the invention provides a method for the dimensional measurement of an object (200) using a co-ordinate measurement machine (100) provided with a measurement probe (110). Preferably, the co-ordinate measurement machine (100) is configured to output positions of the measurement probe (110) or coordinate measurement machine (100) from which an acceleration of the coordinate measurement machine (100) and an apparent dimensional measurement of the object (200) can be calculated, the method comprising the steps of:
(a) moving the coordinate measurement machine (100), for example moving the measurement probe (110) and one or more of the 3 linear machine axes X, Y, and Z (102, 104, 106) of the co-ordinate measurement machine (100), to obtain an apparent dimensional measurement the object (200);
(b) calculating the acceleration of the coordinate measurement machine (100) during said movement, for example calculating the acceleration of the measurement probe (110) and one or more of the 3 linear machine axes X, Y, and Z (102, 104, 106) of the co-ordinate measurement machine (100);
(c) providing a mathematical correction model for predicting a measurement error for a coordinate measurement machine (100) moved to a position at an acceleration, for example depending on general input variables position (P) and acceleration (A);
(d) applying the mathematical correction model to obtain a measurement error for the apparent measurement of the object (200) obtained by moving the coordinate measurement machine (100) at the acceleration; and
(e) correcting the apparent measurement of the object (200) with the measurement error to obtain a corrected measurement of the object (200).

Preferably, the mathematical correction model provided in step (c) was created or refined with the method according to the first aspect of the invention, or according to a preferred embodiment thereof.

In some preferred embodiments according to the second aspect of the invention, the co-ordinate measurement machine (100) outputs the position P(t) of the measurement probe (110) from which the acceleration A(t) of the coordinate measurement machine (100) can be calculated, the method comprising the steps of:
(a) measuring at time t the object (200) to obtain a dimensional measurement of the surface of the object (geometric measurement variable) P(t);
(b) measuring at time intervals the position of the measurement probe (110) from linear scale readings
(c) calculating an acceleration variable A(t);
(d) providing a mathematical correction model for predicting a general measurement error (E) depending on general input variables position (P) and acceleration (A);
(e) applying the mathematical correction model to obtain a measurement error E(t) from A(t) and the position of the measurement probe (110); and
(f) correcting variable P(t) with measurement error E(t) to obtain a corrected variable Pc(t).

Preferably, the mathematical correction model provided in step (d) was created or refined with the method according to the first aspect of the invention, or according to a preferred embodiment thereof.

This method has the advantages that it is generic, applicable in the full measurement volume and it achieves a very accurate compensation of dynamic measurement errors. Therefore, the corrections can be applied quickly, and real-time accurate results can be easily obtained

In some preferred embodiments according to the second aspect of the invention, the positions P(t) defined by one or more of axes X, Y, and Z are obtained via linear scale readings of one or more of the axes X, Y, and Z. In some preferred embodiments according to the second aspect of the invention, the acceleration variable A(t) in step (b) is calculated as the second derivative over time of the position variable P(t), from the prior variation over time of the position of the measurement probe (110). In some preferred embodiments according to the second aspect of the invention, steps (a) to (e) are performed for each time step t.

In a third aspect, the invention provides a computer program, or a computer program product directly loadable into the internal memory of a computer, or a computer program product stored on a computer readable medium, or a combination of such computer programs or computer program products, configured for creating or refining a mathematical correction model for a co-ordinate measurement machine (100) according to the method according to the first aspect of the invention, or preferred embodiments thereof, or configured to perform a dimensional measurement of an object (200) using a co-ordinate measurement machine (100) according to the method according to the second aspect of the invention, or preferred embodiments thereof.

In a fourth aspect, the invention provides a system (1) comprising a co-ordinate measurement machine (100) provided with a measurement probe (110), and a computer (400) comprising the computer program, or the computer program product, according to the third aspect of the invention.

In some preferred embodiments according to the fourth aspect of the invention, the co-ordinate measurement machine (100) is provided with a multipurpose electrical and/or data connection cable (500) for connecting a probe head (112) to a controller unit (132) disposed apart from the co-ordinate measurement machine (100) comprising:
a cable component (510) comprising:
   a co-axial cable (512);
   a twisted pair cable (514);
   optionally, a fibre optic cable; and
   optionally, a multi-strand cable and/or a single-strand cable (516);
a first connector unit (530) comprising one or more connectors (532) for connecting one or more of the cables within the cable component (510) to the probe head (112), optionally via an adapter (600); and
a first coupling unit (540) for dismountably attaching the first connector unit (530) to the probe head (112) or to the adapter (600).

In a fifth aspect, the invention provides a co-ordinate measurement machine (100) comprising a multipurpose electrical and/or data connection cable (500) for connecting a probe head (112) to a controller unit (132) disposed apart from the co-ordinate measurement machine (100) comprising:
a cable component (510) comprising:
   a co-axial cable (512);
   a twisted pair cable (514);
   optionally, a fibre optic cable; and
   optionally, a multi-strand cable and/or a single-strand cable (516);
a first connector unit (530) comprising one or more connectors (532) for connecting one or more of the cables within the cable component (510) to the probe head (112), optionally via an adapter (600); and
a first coupling unit (540) for dismountably attaching the first connector unit (530) to the probe head (112) or to the adapter (600).

In a sixth aspect, the invention provides a multipurpose electrical and/or data connection cable (500) for a co-ordinate measurement machine (100), preferably for a co-ordinate measurement machine (100) as described above, for connecting a probe head (112) to a controller unit (132) disposed apart from the co-ordinate measurement machine (100), comprising:
a cable component (510) comprising:
   a co-axial cable (512);
   a twisted pair cable (514);
   optionally, a fibre optic cable; and
   optionally, a multi-strand cable and/or a single-strand cable (516);
a first connector unit (530) comprising one or more connectors (532) for connecting one or more of the cables within the cable component (510) to the probe head (112), optionally via an adapter (600); and
a first coupling unit (540) for dismountably attaching the first connector unit (530) to the probe head (112) or to the adapter (600).

### BRIEF DESCRIPTION OF THE DRAWINGS

FIG. 1: Schematic representation of a bridge coordinate measurement machine (100) used according to the method according to a preferred embodiment of the invention. The coordinate measurement machine (100) comprises a measurement probe (110) moving at an acceleration (A(n)), which measurement probe (110) has an actual position (Pa(m)) corresponding to an apparent position (Pr(m)) as obtained from the linear scale readings of the axes X, Y, and Z. The measurement probe (110) is connected to the CMM (100) using a probe head (112).

FIG. 2: Schematic representation of a bridge coordinate measurement machine (100) used according to the method according to the second aspect of the invention to measure an object (200). The coordinate measurement machine (100) comprises a measurement probe (110) moving at an acceleration (A(t)), which measurement probe (110) has a measured position (P(t)) as obtained from the linear scale readings of the axes X, Y, and Z corresponding to an actual, corrected position (Pc(t)). The measurement probe (110) is connected to the CMM (100) using a probe head (112).

FIG. 3: Schematic representation of a bridge coordinate measurement machine (100) showing linear axes X, Y, and Z. The coordinate measurement machine (100) comprises a measurement probe (110) and is connected to a computer (400) and to a coordinate measurement machine controller cabinet (130).

FIG. 4: Schematic representation of motion when accelerating a co-ordinate measurement machine (100) along the X-axis or Y-axis respectively for a bridge co-ordinate measurement machine (100) comprising a measurement probe (110).

FIG. 5: Schematic representation of the centre of mass (150) for a bridge co-ordinate measurement machine (100) for various positions along the Y-scale.

FIGS. 6A to C: Schematic representations of the centres of mass (150) for a bridge co-ordinate measurement machine (100) comprising a measurement probe (110) for various positions along the Z-scale.

FIG. 7A: Schematic representation of a connection cable (500) comprising a cable component (510), having first (530) and second (530′) connector units at their terminal ends, whereby the connector components (530) are connected to first (600) and second (600′) adapters with first (540) and second (540′) coupling means respectively, whereby first (600) adapters is coupled to a probe head (112) on one side, and the second (600′) adapter is coupled to a controller unit (132) on the other side.

FIG. 7B: Shows an identical connection cable (500) as shown in FIG. 7A, but with different first (600) and second (600′) adapters for connection to different probe head (112) and controller unit (132) respectively.

FIG. 8: Schematic representation of a cable component (510) comprising a coaxial wire (512), one or more sets of twisted pair wires (514), one or more single-strand or multi-stranded wires or optical fibres (516), filling material (528), a plated copper braid (524), a shielding foil (526), and an outer sheath (522).

FIG. 9: Schematic representation of a coordinate measurement machine (100) comprising a measurement probe (110) and a probe head (112), connected through a connection cable (500) to a coordinate measurement machine controller cabinet (130) comprising a multi-component controller unit (132) containing a probe head controller (134) and a coordinate measurement machine controller (136).

FIG. 10: Schematic representation of different types of measurement probes (110) comprising different types of probe heads (112).

FIG. 11: Schematic representation of measurement errors E and offsets O for a bridge coordinate measurement machine (100).

### DETAILED DESCRIPTION OF THE INVENTION

Before the present system and method of the invention are described, it is to be understood that this invention is not limited to particular systems and methods or combinations described, since such systems and methods and combinations may, of course, vary. It is also to be understood that the terminology used herein is not intended to be limiting, since the scope of the present invention will be limited only by the appended claims.

As used herein, the singular forms “a”, “an”, and “the” include both singular and plural referents unless the context clearly dictates otherwise.

The terms “comprising”, “comprises” and “comprised of” as used herein are synonymous with “including”, “includes” or “containing”, “contains”, and are inclusive or open-ended and do not exclude additional, non-recited members, elements or method steps. It will be appreciated that the terms “comprising”, “comprises” and “comprised of” as used herein comprise the terms “consisting of”, “consists” and “consists of”.

The recitation of numerical ranges by endpoints includes all numbers and fractions subsumed within the respective ranges, as well as the recited endpoints.

Whereas the terms “one or more” or “at least one”, such as one or more or at least one member(s) of a group of members, is clear per se, by means of further exemplification, the term encompasses inter alia a reference to any one of said members, or to any two or more of said members, such as, e.g., any ≥3, ≥4, ≥5, ≥6 or ≥7 etc. of said members, and up to all said members.

All references cited in the present specification are hereby incorporated by reference in their entirety. In particular, the teachings of all references herein specifically referred to are incorporated by reference.

Unless otherwise defined, all terms used in disclosing the invention, including technical and scientific terms, have the meaning as commonly understood by one of ordinary skill in the art to which this invention belongs. By means of further guidance, term definitions are included to better appreciate the teaching of the present invention.

In the following passages, different aspects of the invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to a person skilled in the art from this disclosure, in one or more embodiments. Furthermore, while some embodiments described herein include some but not other features included in other embodiments, combinations of features of different embodiments are meant to be within the scope of the invention, and form different embodiments, as would be understood by those in the art. For example, in the appended claims, any of the claimed embodiments can be used in any combination.

In the present description of the invention, reference is made to the accompanying drawings that form a part hereof, and in which are shown by way of illustration only of specific embodiments in which the invention may be practiced. Parenthesized or emboldened reference numerals affixed to respective elements merely exemplify the elements by way of example, with which it is not intended to limit the respective elements. It is to be understood that other embodiments may be utilised and structural or logical changes may be made without departing from the scope of the present invention. The following detailed description, therefore, is not to be taken in a limiting sense, and the scope of the present invention is defined by the appended claims.

A first aspect of the invention provides a method for creating or refining a mathematical correction model for correcting measurement errors in a co-ordinate measurement machine (100) having at least 3 linear machine axes (102, 104, 106), each comprising a machine linear scale (102′, 104′, 106′), and provided with a measurement probe (110), comprising accelerating the co-ordinate measurement machine (100) along one of the linear machine axes, for example by accelerating the measurement probe (110) and at least one of the 3 linear machine axes X, Y, and Z (102, 104, 106) of the co-ordinate measurement machine (100) along one of the linear machine axes (102, 104, 106), and creating or refining the mathematical correction model using the acceleration, apparent measurement probe (110) position and actual measurement probe (110) position. The method is preferably performed without using a reference object; a reference object typically has known dimensions and/or shape such as a sphere or ring.

Hence, in some preferred embodiments, the invention provides a method for creating or refining a mathematical correction model for correcting measurement errors in a co-ordinate measurement machine (100) having at least 3 linear machine axes X, Y, and Z (102, 104, 106) each comprising a machine linear scale (102′, 104′, 106′) and provided with a measurement probe (110), comprising the steps:
(i) accelerating the co-ordinate measurement machine (100) along one of the linear machine axes (102, 106, 106), for example by accelerating the measurement probe (110) and at least one of the 3 linear machine axes X, Y, and Z (102, 104, 106) of the co-ordinate measurement machine (100) along one of the linear machine axes (102, 104, 106);
(ii) measuring the apparent position of the measurement probe (110) using the machine linear scale (102′, 104′, 106′) and synchronously measuring the actual position of the measurement probe (110);
(iii) calculating measurement errors as a function of coordinate measurement machine (100) acceleration and apparent and actual measurement probe (110) position;
(iv) repeating steps (i) to (iii) for different coordinate measurement machine (100) positions and accelerations; and
(v) defining or refining a mathematical correction model using the measurement errors at different coordinate measurement machine (100) positions and accelerations

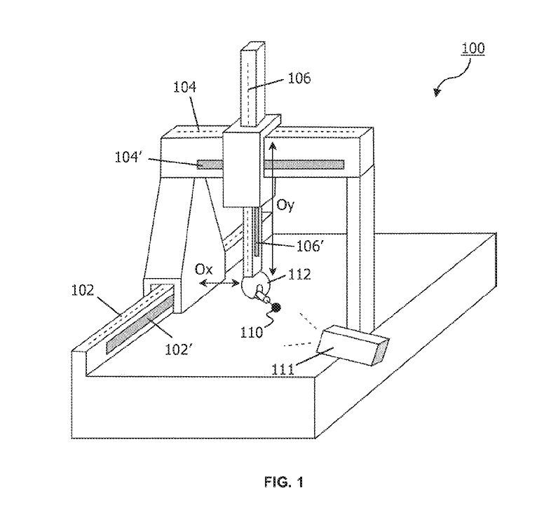

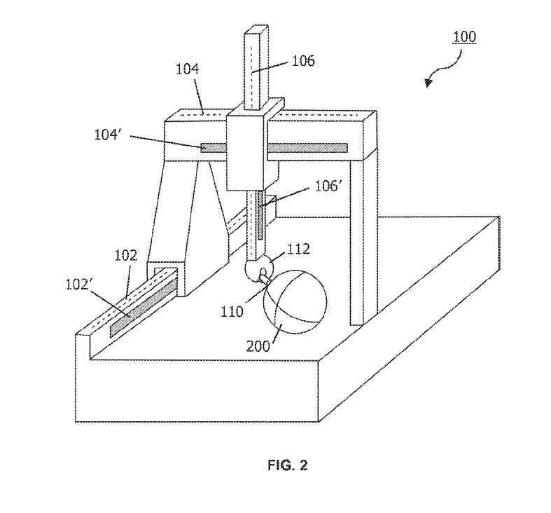

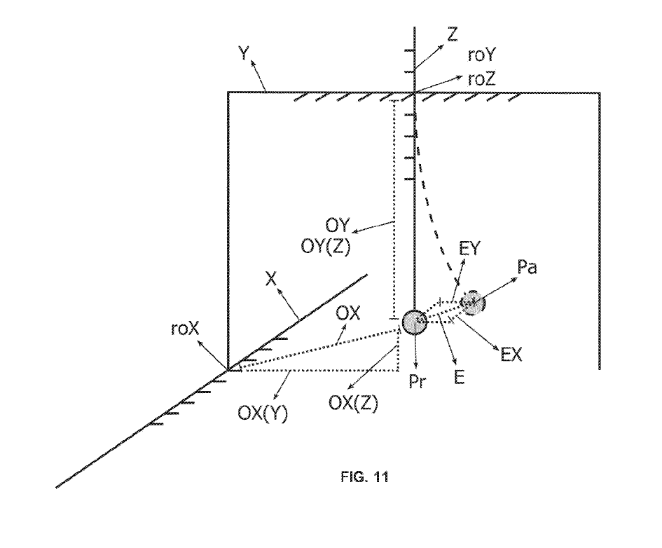

The mathematical correction model preferably comprises one or more correction terms each for the measurement (read-off) of a machine linear scale and which corrects for the measurement error along that machine linear scale (102′, 104′, 106′). Preferably, there is one correction term for each of the X and Y machine linear scales (102′, 104′), optionally for all machine linear scales (102′, 104′, 106′). The mathematical correction model preferably comprises a correction term related to an offset for one or more of the machine linear scales (102′, 104′, 106′), which offset is defined as the distance between the measurement probe (110) and the respective machine linear scale (102′, 104′, 106′) (i.e. the linear scale that is the subject of the offset in question). Preferably, it is defined as the distance between the measurement probe (110) and the read-off point on the respective machine linear scale (102′, 104′, 106′), preferably defined as the linear distance between the measurement probe (110) and the read-off point on the respective machine linear scale (102′, 104′, 106′). Preferably the distance is derived, for example calculated, from the reading of the machine linear scale (102′, 104′, 106′). Preferably, the distance is based on the apparent position of the measurement probe (110). FIGS. 1 and 11 illustrate the offsets OX and OY, which are related to the measurement error E; the offset OZ typically gives rise to a negligible error, hence does not contribute much to the measurement error E, and is not shown here.

FIG. 11 illustrates a simplified CMM, with an exaggerated difference between actual position Pa of the measurement probe and apparent position Pr of the measurement probe, for sake of clarity. The difference shown in FIG. 11 is due to acceleration caused when the CMM is driven along the X- and Y-axes, whereby the driving vector does not intersect the center of mass of the CMM (whereby the center of mass is based on the CMM including the probe head and probe). The apparent position Pr can be read off (ro) from the linear scales X, Y, and Z, in read-off points roX, roY, and roZ, respectively. The measurement error E is shown as the difference between the actual position Pa and the apparent position Pr. X- and Y-components of the measurement error E are shown as EX and EY respectively, while the Z-component EZ is not explicitly shown (negligible compared to EX and EY in this case). The measurement error E is related to the offsets OX and OY, which can be defined as the distance (preferably calculated from the read-off points roX, roY, and roZ) between the measurement probe and the X and Y axis respectively, more in particular the distance (preferably calculated from the read-off points roX, roY, and roZ) between the measurement probe and the read-off points roX and roY respectively. In some embodiments, the offset is measured according to the actual position Pa, but in preferred embodiments it is measured according to apparent position Pr (preferably calculated from the read-off points roX, roY, and roZ). In FIG. 11 the distance with the apparent position Pr of the measurement probe is shown, which is only slightly different from the distance with the actual position Pa of the measurement probe (note that the measurement error E is shown in an exaggerated size compared to the relative size of the CMM). For practical purposes, the offsets OX and OY are determined from the apparent position Pr instead of from the actual position Pa, since the former can be easily read off from the read-off points roX, roY and roZ. As shown in FIG. 11, the offset OX comprises a Y-component OX(Y) and a Z-component OX(Z), while the offset OY only comprises a Z-component OY(Z).

FIG. 11 describes bridge type CMMs with a specific X/Y/Z axis convention. The present method applies to any build type of CMM, in which case the convention for X/Y/Z may differ.

The mathematical correction model preferably comprises a correction term for the measurement along the X-axis (102) (in order to correct for the error EX along the X-axis), wherein the correction term is dependent on the acceleration along the X-axis (102) as measured by reading off roX on the machine linear scale along the X-axis (102′), and dependent on the Y-position and Z-position as measured by reading off roY and roZ on the machine linear scales along the Y-axis and Z-axis (104′,106′), respectively.

The mathematical correction model preferably comprises a correction term for the measurement along the Y-axis (104) (in order to correct for the error along the Y-axis), wherein the correction term is dependent on the acceleration along the Y-axis (104) as measured by reading off roY on the machine linear scale along the Y-axis (104′), and dependent on the Z-position as measured along by reading off roZ on the machine linear scale along the Z-axis (106′).

In some preferred embodiments, the mathematical correction model comprises a correction term for the measurement along the X-axis (102) (in order to correct for the error EX along the X-axis), wherein the correction term is dependent on the acceleration along the X-axis (102) as measured by reading off roX on the machine linear scale along the X-axis (102′), and dependent on the Y-position and Z-position as measured by reading off roY and roZ on the machine linear scales along the Y-axis and Z-axis (104′,106′), respectively; and the mathematical correction model comprises a correction term for the measurement along the Y-axis (104) (in order to correct for the error along the Y-axis), wherein the correction term is dependent on the acceleration along the Y-axis (104) as measured by reading off roY on the machine linear scale along the Y-axis (104′), and dependent on the Z-position as measured along by reading off roZ on the machine linear scale along the Z-axis (106′).

More specifically, the invention provides a method for creating or refining a mathematical correction model for predicting a general measurement error E depending on general input variables position P (geometric measurement) and acceleration A of dimensional measurements obtained from a co-ordinate measurement machine (100) comprising 3 linear machine axes X, Y, and Z and provided with a measurement probe (110) for the dimensional measurement of an object (200). Preferably, the method comprising the steps of:
(i) accelerating the co-ordinate measurement machine (100) along an axis selected from X, Y, or Z, for example by accelerating the measurement probe (110) and at least one of the 3 linear machine axes X, Y, and Z (102, 104, 106) of the co-ordinate measurement machine (100) along one of the linear machine axes (102, 104, 106);
(ii) performing a non-contact measurement of the actual position Pa(m) of the measurement probe (110) for one or more apparent positions Pr(m) using the measurement probe (110) moved at one or more different accelerations A(n) at one or more different positions Pr(m);
(iii) calculating a dimensional measurement error E(mn) for each acceleration A(n) of the coordinate measurement machine (100) at each position Pr(m) based on Pa(m);
(iv) repeating the procedure for different measurement probe (110) positions m and/or accelerations n; and
(v) creating or refining a mathematical correction model for predicting a general measurement error E depending on general input variables position P and acceleration A, which mathematical correction model is derived from E(mn), Pr(m) and A(n).

The actual position Pa of the measurement probe (110) is the true position of the measurement probe and is typically measured using a second, overseeing non-contact measurement system (111) described later below. The apparent position Pr of the measurement probe (110) is the erroneous position of the measurement probe i.e. which contains the measurement error, as read off the linear scales.

As used herein, position and geometric measurement data comprise x, and/or y and/or z coordinates, and are implicitly assumed to have the form P(x,y,z). These data can be time dependent, and can be noted as P(x(t),y(t),z(t)).

Acceleration data comprises x and/or y and/or z coordinates, and are implicitly assumed to have the form A(ax,ay,az). These acceleration data can be time dependent, and can be noted as A(ax(t),ay(t),az(t)), or in some embodiments as A(ax(t),ay(t)), for example when az(t) is negligible. Typically, the acceleration coordinates ax(t), ay(t), and az(t) are second derivatives over time of the position coordinates x(t), y(t), and z(t). The position coordinates in the first aspect of the invention are discrete position coordinates corresponding to discrete measuring points, and are therefore indicated as P(m) with a discrete counter m, which can be any natural number ranging from 1 to infinity. The counter m may be linked to a pre-set time step (and can then be noted as P(t)), or may be linked to a pre-set position change. A similar reasoning holds for the acceleration A(n) which refers to a counter n, which can be any natural number ranging from 1 to infinity. The counter n may be linked to a pre-set time step (and can then be noted as A(t), or may be linked to a pre-set position change. Counters m and n may be equal or different. The dimensional measurement error E(mn) is dependent on counters m and n.

For example, the dimensional measurement error E(mn) for an acceleration A(n) may be the simple difference between the actual position Pa(m) measured by the non-contact probe and the apparent position Pr(m), for example measured by the linear scales. For a simplified example with 4 apparent positions and three accelerations, the dimensional measurement error may be calculated as follows, whereby the actual position Pa(m) and apparent position Pr(m) for each point m is measured at an acceleration A(n) (herein noted as @A(n)):

$$[ \begin{matrix}E ( 11 ) & E ( 12 ) & E ( 13 ) \\ E ( 21 ) & E ( 22 ) & E ( 23 ) \\ E ( 31 ) & E ( 32 ) & E ( 33 ) \\ E ( 41 ) & E ( 42 ) & E ( 43 )\end{matrix} ] = [ \begin{matrix}[ P a ( 1 ) - Pr ( 1 ) ] @ A ( 1 ) & [ P a ( 1 ) - Pr ( 1 ) ] @ A ( 2 ) & [ P a ( 1 ) - Pr ( 1 ) ] @ A ( 3 ) \\ [ P a ( 2 ) - Pr ( 2 ) ] @ A ( 1 ) & [ P a ( 2 ) - Pr ( 2 ) ] @ A ( 2 ) & [ P a ( 2 ) - Pr ( 2 ) ] @ A ( 3 ) \\ [ P a ( 3 ) - Pr ( 3 ) ] @ A ( 1 ) & [ P a ( 3 ) - Pr ( 3 ) ] @ A ( 2 ) & [ P a ( 3 ) - Pr ( 3 ) ] @ A ( 3 ) \\ [ P a ( 4 ) - Pr ( 4 ) ] @ A ( 1 ) & [ P a ( 4 ) - Pr ( 4 ) ] @ A ( 2 ) & [ P a ( 4 ) - Pr ( 4 ) ] @ A ( 3 )\end{matrix} ]$$

whereby the difference may be expressed as the difference in Cartesian coordinates:

$$[ P a ( m ) - Pr ( m ) ] @ A ( n ) = [ \begin{matrix}xa ( m ) @ A ( n ) \\ ya ( m ) @ A ( n ) \\ za ( m ) @ A ( n )\end{matrix} ] - [ \begin{matrix}xr ( m ) @ A ( n ) \\ y r ( m ) @ A ( n ) \\ zr ( m ) @ A ( n )\end{matrix} ] = [ \begin{matrix}[ xa ( m ) - xr ( m ) ] @ A ( n ) \\ [ ya ( m ) - y r ( m ) ] @ A ( n ) \\ [ za ( m ) - zr ( m ) ] @ A ( n )\end{matrix} ]$$

In some embodiments, the deviations along the X, Y, and Z linear machine axes are measured one at a time. This means that in some parts, the error matrix E(mn) may only contain values for one of the three axes, instead of all three.

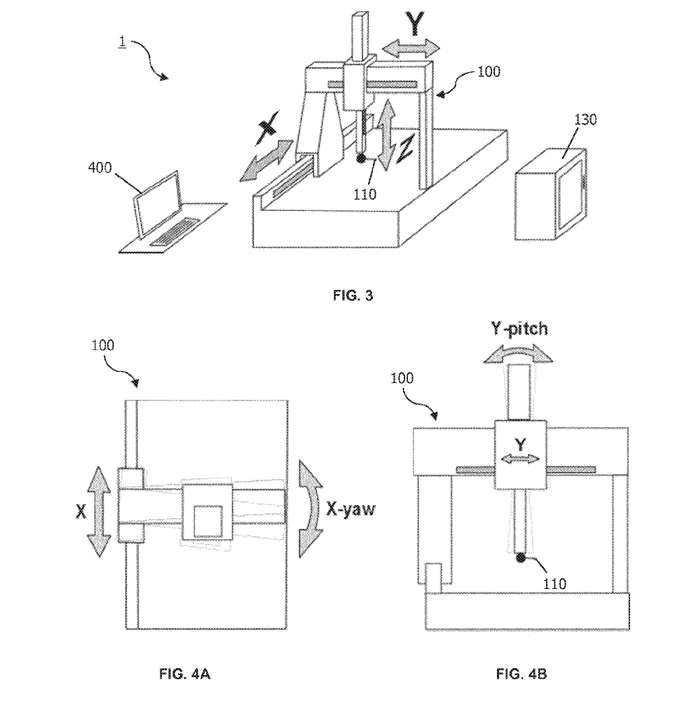

The co-ordinate measuring machine (100) is defined by at least 3 linear machine axes (X, Y and Z-axis). The machine axes are preferably designed to be straight and perpendicular with respect to each other within very narrow tolerances. For instance, it may have a typical straightness of 0.002 mm over 100 mm, or of 0.020 mm over the full length. In some preferred embodiments, the 3 linear machine axes X, Y, and Z are essentially straight and essentially perpendicular with respect to each other. The method may be particularly suited to model bridge machines. In some embodiments, the co-ordinate measurement machine (100) is a bridge co-ordinate measurement machine (100). FIG. 3 illustrates a bridge co-ordinate measurement machine (100) with 3 linear machine axes X, Y, and Z that are essentially straight and essentially perpendicular with respect to each other. A typical “3 bridge CMM” or bridge CMM is composed of three measurement axes: X, Y, and Z. These axes are typically orthogonal to each other in a typical three dimensional coordinate system.

Each axis usually has a machine linear scale. The linear scale is a measurement system from which the apparent position of the measurement probe (110) along that axis can be read off. It typically outputs signals corresponding to the apparent position of the measurement probe. It may comprise, for instance, a linear encoder. The linear scale may be an inductive linear scale. Signals from the linear scales, optionally combined with readings from the probe head are used to calculate the position of the probe i.e. in x, y, z co-ordinates. When an object is being measured, the aforementioned signals may be combined with signals from the probe to determine the dimensions of the object, typically up to micrometre precision. Such machines are well known in the art, and are commercially available from Nikon Metrology, such as Altera, Evolution, HC90, Ultima, Colossus etc.

The end effector of the CMM may be fitted with a probe head. For most CMMs, the end effector is the end effector of the Z-axis, for example the end of a quill or spindle, whereby the quill or spindle provides the measurement along the Z-axis of the CMM. A probe head is well known in metrology applications as an adaptor for attachment of a measurement probe to the co-ordinate measurement machine. Examples of probe heads include the PH-10 series manufactured by Renishaw. Advantageously, the probe head further serves to angularly orientate the measurement probe relative to the end effector of the co-ordinate measurement machine; typically a probe head has two axes of rotation, optionally motorised. While the figures here show the presence of a probe head (112), it is appreciated that a probe head is not a requirement for attachment of the measurement probe to the CMM.

Using a probe head (112), the position of the probe relative to the centre of the probe head can be set by the user, and hence, the probe can be additionally offset in X, Y and Z directions relative to the centre of the probe head. Any dynamic movement of the CMM can induce angular errors of the probe head (112) which when multiplied by the additional offsets can lead to significant errors in the position of the probe when measured along the linear scales. The present method has the surprising advantage that it can correct for these errors as well as the errors present at the centre of the probe head (112).

The measurement probe (110) is configured for the dimensional measurement of an object (200). The measurement probe is provided with a coupling for attachment to the CMM (100) optionally via a probe head (112). The measurement probe (110) may be any type of dimensional measurement probe, optionally that outputs signals corresponding to dimensional measurements of the object (200). The signals may be any such as electrical, optical or electromagnetic (e.g. radio signals). Typical measurement probes (110) include an optical probe (e.g. optical scanning probe, laser scanner, profile probe), touch contact probe, or camera. The measurement probe (110) typically comprises a detector for detecting a measurement parameter such as light or force. A touch contact probe typically comprises a touch-trigger assembly in addition to signal-generating components.

The measurement probe may be an optical probe. Typically an optical probe comprises an optical detector for detecting light reflected by the object to be measured, in addition to the signal-generating components. The optical detector may be one or two dimensional. The optical detector may comprise a CMOS or CCD sensor. The optical detector may comprise a lens system for focusing light from the object. A light source such as a laser may be included in the optical probe or may be separate. The laser may project a single stripe, multiple stripes that may or may not cross, or a geometric pattern.

The method (for example in step (i)) comprises accelerating the co-ordinate measurement machine (100) along an axis selected from X, Y, or Z, for example by accelerating the measurement probe (110) and at least one of the 3 linear machine axes X, Y, and Z (102, 104, 106) of the co-ordinate measurement machine (100) along one of the linear machine axes (102, 104, 106). Preferably, the acceleration is along only one axis at a time. It is a preferred aspect of the invention that acceleration simultaneously along two or more axes is not performed. Preferably, acceleration is along one axis, the selected axis, while the other two axes remain in a fixed position.

The dynamic error at the centre of the probe can be calculated from the combination of the measured acceleration values at the linear scales and the mathematical correction model of the CMM (100) calculated from the apparent and actual position of the measurement probe (110). However, since the centre of mass is dependent on the position of the axis, multiple measurements may be performed per axis to obtain the mathematical correction model.

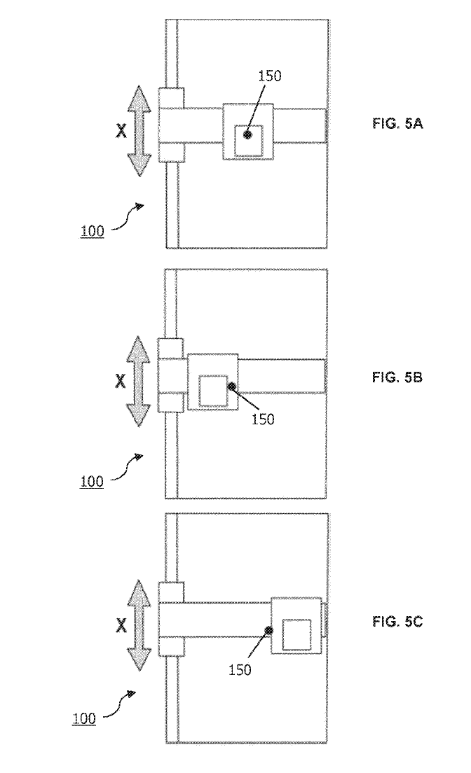

Typically for the X-axis numerous data collection runs could be made using different combinations of Y and Z positions which are fixed during accelerations along the X-axis to establish enough data to describe a function Eₓ(Y, Z, Aₓ) (typical axis combinations are shown in FIGS. 5A-C and 6A-C). This function would have as variables: X axis acceleration and Y and Z positions.

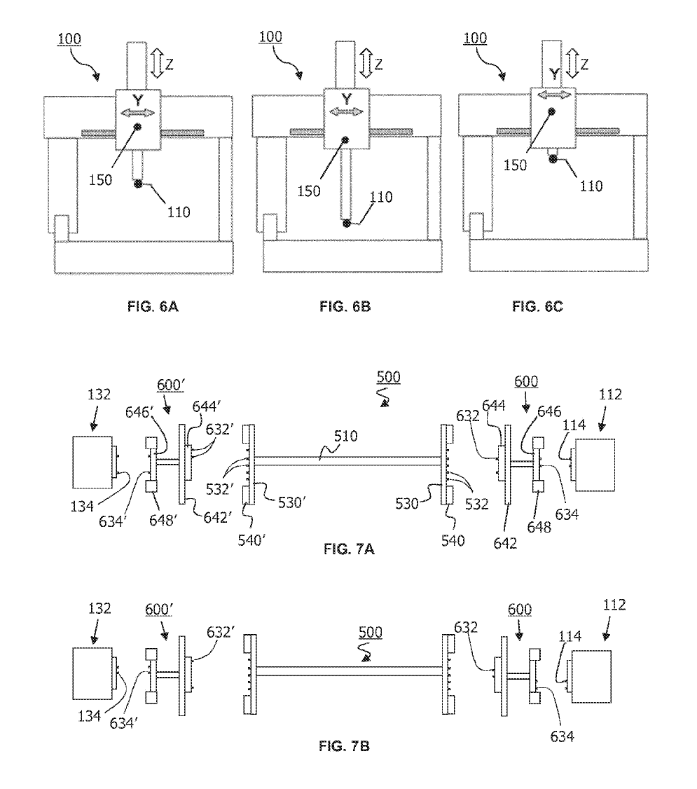

Likewise in the Y axis numerous data collection runs could be made at different Z positions which are fixed during accelerations along the Y-axis to establish enough data to describe a function E_{y}(Z,A₁); typical axis combinations are shown in FIGS. 6A-C. This function would have as variables: Y axis acceleration and Z traverse positions.

The amount of data collection may vary with machine size and desired accuracy of the finished model. However interpolation will preferably be used to provide values for sections of the volume that have not been explicitly calibrated, even though other methods can also be used. This interpolation would typically be achieved by the use of cubic splines to define Eₓ(Y,Z,Aₓ) and E_{y}(Z,A_{y}) although the mathematical approach to this interpolation is not intended to be limited by this invention so could be tables, continuous polynomial functions or any other function.

This method has the advantage that the full volume can be quickly and cheaply calibrated, and that the change in centre of mass can be taken into account. Furthermore, this method has the advantage that no additional tools, such as a ring gauge, are required.

The method (for example in step (iv)) preferably comprises repetition. The repetition may be performed in several different ways. For instance, for the axis selected from X, Y or Z:
the fixed position of the measurement probe (110) in one or both of the other two axes may be different;
the acceleration along the selected axis may be different;
the position of the acceleration along the selected axis may be different; or
a combination of two or more of the above.

The repetition also encompasses the selection from X, Y or Z of a different axis. The more repetitions performed using different selected axes, at different fixed positions of one or both of the other axes, at different accelerations, at different positions of accelerations, the more information about behaviour of the CMM within the measurement volume becomes available, and hence the better the mathematical correction model.

Measuring the actual position of the measurement probe (110), for example in step (ii), is typically performed using an external measurement system, for instance a non-contact measurement system (111), that is different and separate from the machine linear scales (102′, 104′, 106′) of the co-ordinate measurement machine (100). It is also separate and different from the measurement probe (110). In other words, the non-contact measurement in step (ii) determines values for Pa(m). The non-contact measurement system (111) preferably has a measurement volume that encompasses the range of movement of the axis being measured. Preferably, the non-contact measurement system (111) is a laser-based non-contact measurement system, for example a laser interferometer, a laser tracker, or a laser distance sensor, which are well known in the art.

The non-contact measurement system (111) can be a three dimensional (3D) measurement system, a two dimensional (2D) measurement system, or a one dimensional (1D) measurement system (111). In some preferred embodiments, the non-contact measurement system (111) is a one dimensional measuring system, set up to measure the position along one axis at a time. Especially combined with error measurements along individual axes instead of using motion in multiple directions (e.g. when using a ring gauge), this has the advantage of providing a cost-effective and easily implemented, yet accurate method.

The moving machine parts of the CMM (100) may be mounted onto a fixed base using air bearings for accurate and smooth displacement. The bearings can be arranged in a specific configuration for optimal performance. The CMM (100) machine parts can be driven by an electrical motor and a mechanical drive system. The apparent position of the CMM (100) machine parts, relative to each other, is accurately measured using linear scales. In some preferred embodiments, the apparent positions Pr(m) defined by the X, Y, and Z axes are obtained via linear scale readings of the axes X, Y, and/or Z.

An assumption may be made that the CMM (100) machine parts move relative to each other in a repeatable way. The repeatable part of such deviations can be corrected by geometric compensation. FIG. 4A shows the Yaw motion when accelerating a CMM along the X-axis for the bridge co-ordinate measurement machine (100) shown in FIG. 3. FIG. 4B shows the motion when accelerating a CMM (100) along the Y-axis for the bridge co-ordinate measurement machine (100) shown in FIG. 3. The dynamic position error will typically depend on the measurement probe (110) position in the measurement volume, the amplitude of the accelerations, and the history of the motion.

In some preferred embodiments, the mathematical correction model further utilises one or more mechanical properties of the co-ordinate measurement machine (100), most preferably of one or more, preferably all of the axes. It may further utilise the centre of mass of the co-ordinate measurement machine axes, most preferably of one or more, preferably all of the axes.

In some preferred embodiments, mechanical properties comprise the stiffness and/or the mass, for example wherein one or more of the co-ordinate measurement machine axes comprise air bearings. The method may be particularly suited to model machines having ceramic axes, due to the combination of stiff structures and flexible joints (such as air bearings). The stiffness of the bearings may be identified in a specific measurement setup. In some embodiments, the co-ordinate measurement machine (100) is a ceramic co-ordinate measurement machine (100), preferably a ceramic bridge co-ordinate measurement machine (100). In another embodiment, the co-ordinate measurement machine (100) is an aluminium co-ordinate measurement machine (100), preferably an aluminium bridge co-ordinate measurement machine (100). In some preferred embodiments, the dynamic rotation is based on the measurement of the acceleration of a specific point of the moving body and the known model of the CMM (100) mass and/or stiffness.

As the acceleration of the coordinate measurement machine (100), for example the acceleration of the measurement probe (110) and one or more of the 3 linear machine axes X, Y, and Z (102, 104, 106) of the co-ordinate measurement machine (100) along one of the linear machine axes (102, 104, 106), can be deduced from the accurate position measurement by the machine linear scales, (double derivative), the present method does not require additional hardware to be installed and as such can be considered a low cost added value. In some preferred embodiments, the acceleration variables A(t)=(A_{X}(t),A_{Y}(t),A_{Z}(t)), along axis X, Y or Z are calculated as the second derivative over time of the position variables P(t)=(X(t),Y(t),Z(t)), from the prior variation over time of the position of the measurement probe (110).

$${A}_{X} ( t ) = \frac{{d}^{2} X ( t )}{{dt}^{2}}$$

$${A}_{Y} ( t ) = \frac{{d}^{2} Y ( t )}{{dt}^{2}}$$

$${A}_{Z} ( t ) = \frac{{d}^{2} Z ( t )}{{dt}^{2}}$$

The acceleration value is preferably calculated continuously at high frequency. Filtering techniques may be used to cancel side effects such as discretisation noise.

The compensation of the measurement probe (110) dynamic deviation may be applicable to the compensation of measurement positions only (e.g. corresponding to a touch probing trigger signal or a sync signal of an analogue probe). In order for the compensation to be synchronized with the trigger pulses, the estimation based on derived acceleration may be calculated continuously. Calculated values and trigger events may be time stamped to match the exact trigger event with the corresponding value in the calculated accelerations. Interpolation between time-stamped calculated values may be required for optimal accuracy. Interpolation may use functions, such as splines or continuous polynomial functions, preferably cubic splines, or tables.

As described above the probe is also subject to static errors which are typically fully corrected for prior to applying the dynamic error correction discussed so far. In fact the static errors have preferably all been measured and the error correction software to be running prior to collecting the dynamic error data. Different methods to obtain corrections for static errors are known in the art, and the skilled person will know what method to use.

Often, the static errors to the centre of the probe head form the only error correction applied to a CMM. More sophisticated packages however, further enhance this correction by adding the combination of static errors present at the probe head to determine the total error that the probe head is experiencing at any point in the volume and multiplies this against the Prₓ, Pr_{y}, Pr_{z} offsets from the centre of the stylus to the centre of the probe head to determine and correct for the probe offsets.

A further enhancement of the invention disclosed herein is the ability to determine the probe head error caused by the dynamic behaviour of the CMM and add these values to the static values that have already been corrected for in an existing software package and thereby provide static and dynamic probe head angular correction.

Determination of the probe head dynamic angular errors may be collected in one of two preferred ways. Firstly the calibration data collected as described previously can be used to provide a good estimation with no further requirement to collect further data:

X dynamic=(Ex(Y,Z,Ax)Y(OX(Y))*Pr(Y)

Y dynamic=(Ey(Z,Ay)/(OY(Z))*Pr(Z)+(Ex(Y,Z,Ax)/(OX(Y))*Pr(X))

Where Pr(Y) represents the probe offset in Y, Pr(X) represents the probe offset in X and Pr(Z) represents the probe offset in Z.

In some preferred embodiments, only the X and Y dynamic are calculated. In some preferred embodiments, the Z dynamic is not calculated. In the above example, the X dynamic error is only contributed to by the probe offset in Y, and the Y dynamic has two components: one is the offset in Z multiplied by the dynamic Y pitch, and the second is the offset in X multiplied by the dynamic X yaw.

This technique has the advantage that it manages to correct for dynamic probe offsets with no additional data capture.

Alternatively, laser angular optics can be used to capture actual measured dynamic angular errors and these can be used to enhance the static data to correct for the actual probe offset dynamic errors. This technique has the advantage of being more direct and therefore being more accurate.

There are multiple methods to estimate and calibrate the dynamic behavior of the CMMs mechanical structure. These methods can involve external equipment, such as a laser interferometer or a laser tracker, such as a laser distance sensor. In some preferred embodiments, the non-contact measurement, for example in step (ii), is a dynamic laser measurement, preferably using a laser interferometer or a laser distance sensor. Other methods would use the CMM (100) metrology functionality without additional external devices.

In a second aspect, the invention provides a method for the dimensional measurement of an object (200) using a co-ordinate measurement machine (100) provided with a measurement probe (110), which co-ordinate measurement machine (100) is configured to output positions of the measurement probe (110) from which an acceleration of the coordinate measurement machine (100), for example an acceleration of the measurement probe (110) and one or more of the 3 linear machine axes X, Y, and Z (102, 104, 106) of the co-ordinate measurement machine (100), and an apparent dimensional measurement of the object (200) can be calculated, the method comprising the steps of:
(a) moving the measurement probe (110) to obtain an apparent dimensional measurement the object (200);
(b) calculating the acceleration of the coordinate measurement machine (100) during said movement (from the CMM linear scales), for example calculating the acceleration of the measurement probe (110) and at least one of the 3 linear machine axes X, Y, and Z (102, 104, 106) of the co-ordinate measurement machine (100) during said movement (from the CMM linear scales);
(c) providing a mathematical correction model for predicting a measurement error for a measurement probe (110) moved to a position at an acceleration for example depending on general input variables position (P) and acceleration (A);
(d) applying the mathematical correction model to obtain a measurement error for the apparent measurement of the object (200) obtained by moving the coordinate measurement machine (100) at the acceleration; and
(e) correcting the apparent measurement of the object (200) with the measurement error to obtain a corrected measurement of the object (200).

The mathematical correction model preferably comprises a correction term for the measurement along the Y-axis (104) (in order to correct for the error along the Y-axis), wherein the correction term is dependent on the acceleration along the Y-axis (104) as measured by reading off roY on the machine linear scale along the Y-axis (104′), and dependent on the Z-position as measured along by reading off roZ on the machine linear scale along the Z-axis (106′).

In some preferred embodiments, the mathematical correction model comprises a correction term for the measurement along the X-axis (102) (in order to correct for the error EX along the X-axis), wherein the correction term is dependent on the acceleration along the X-axis (102) as measured by reading off roX on the machine linear scale along the X-axis (102′), and dependent on the Y-position and Z-position as measured by reading off roY and roZ on the machine linear scales along the Y-axis and Z-axis (104′,106′), respectively; and the mathematical correction model comprises a correction term for the measurement along the Y-axis (104) (in order to correct for the error along the Y-axis), wherein the correction term is dependent on the acceleration along the Y-axis (104) as measured by reading off roY on the machine linear scale along the Y-axis (104′), and dependent on the Z-position as measured along by reading off roZ on the machine linear scale along the Z-axis (106′).

More specifically, the second aspect of the invention provides a method for the dimensional measurement of an object (200) using a co-ordinate measurement machine (100) provided with a measurement probe (110), which co-ordinate measurement machine (100) outputs the position P(t) of the measurement probe (110) from which the acceleration A(t) of the coordinate measurement machine (100) can be calculated, the method comprising the steps of:
(a′) measuring at time t the object (200) to obtain a position variable P(t); preferably repeating the measurement at regular time intervals.
(b′) calculating an acceleration variable from the position variable P(t), preferably taken at at least 3 successive timing points A(t);
(c′) providing a mathematical correction model for predicting a general measurement error (E) depending on general input variables position (P) and acceleration (A);
(d′) applying the mathematical correction model to obtain a measurement error E(t) from variables P(t) and A(t); and
(e′) correcting position variable P(t) with measurement error E(t) to obtain a corrected position variable Pc(t).

Preferably, the mathematical correction model provided in step (c′) was created or refined with the method according to the first aspect of the invention, or according to a preferred embodiment thereof.

As the position coordinates in the second aspect of the invention are discrete position coordinates corresponding to discrete measuring points corresponding to a time step, they are therefore indicated as P(t). The time-step may be a pre-set fixed time step, or may be a variable time step. A similar reasoning holds for the acceleration A(t) which refers to the same time step. The dimensional measurement error E(t) is dependent on the time step.

The method according to the second aspect of the invention is particularly suitable for high speed scanning, such as high speed laser scanning. In some preferred embodiments, the measurement in step a) is performed by high speed laser scanning.

In some preferred embodiments according to the second aspect of the invention, the positions P(t) defined by one or more of axes X, Y, and Z are obtained via linear scale readings of one or more of the axes X, Y, and Z. The acceleration can be deduced from the variation over time of the linear scale readout. The difference of the machine linear scale reading over fixed time intervals will display the velocity. The difference of velocity readings over fixed time intervals will indicate the acceleration. The timing interval may be optimized for best performance and to avoid side effects such as quantization noise. In some preferred embodiments according to the second aspect of the invention, the acceleration variable A(t) in step (b) is calculated as the second derivative over time of the position variable P(t), from the prior variation over time of the position of the measurement probe (110).

In some preferred embodiments according to the second aspect of the invention, steps (a) to (e) are performed for each time step t. The time t may be between 0.2 and 20 ms, preferably around 1 ms.

In a third aspect, the invention provides a computer program, or a computer program product directly loadable into the internal memory of a computer, or a computer program product stored on a computer readable medium, or a combination of such computer programs or computer program products, configured for creating or refining a mathematical correction model for a co-ordinate measurement machine (100) according to the method according to the first aspect of the invention, or preferred embodiments thereof, or configured to perform a dimensional measurement of an object (200) using a co-ordinate measurement machine (100) according to the method according to the second aspect of the invention, or preferred embodiments thereof.

In a fourth aspect, the invention provides a system (1) comprising a co-ordinate measurement machine (100) provided with a measurement probe (110), and a computer (400) comprising the computer program, or the computer program product, according to the third aspect of the invention. The co-ordinate measurement machine (100) may be controlled by a coordinate measurement machine controller cabinet (130). In some embodiments, the controller cabinet (130) comprises a controller (132). In some embodiments, the co-ordinate measurement machine (100) is controlled by a controller (132), either indirectly through a controller cabinet (130) or directly without the presence of a controller cabinet (130).

The invention also comprises a multi-wire cable that allows different indexing heads (also known as probe heads) and controllers to be used with a coordinate measurement machine, preferably with a coordinate measurement machine (100) as described above. Traditionally, the wiring solution assembled in a coordinate measurement machine is dictated by the indexing head chosen by the end user, or conversely, the end user can only use an indexing head which can be connected to the particular wiring solution assembled in the coordinate measurement machine. The invention comprises a single cable with different wiring formats (e.g. twisted pair, coax, optical fibre, etc.), together with different termination connectors, or an adaptor. This allows different indexing heads to be used and also enables retrofitting different indexing heads to the coordinate measurement machine without the need to disassemble the machine (as is the case at present, because the wiring will need to match the new indexing head).

In the art, the cable normally provides the necessary connections between the measurement probe (110) and a controller unit through the probe head. The probe head (112) is reversibly mountable at one end onto the moving part of the coordinate measurement machine (100), and contains a mounting at the other end for dismountable connection to a measurement probe (110). The probe head typically contains one or two axes of rotation, and hence holds a mechanical, optical or other type of probing device in a specific arrangement: position and orientation. The controller is an electronic device which powers and drives the probe head (112) and which may processes the measurement signal from the measurement probe (110) in order to create a dimensional measurement. It is typically disposed apart from the coordinate measurement machine (100).

The probe head (112) is typically disposed with a connector having one or more individual connections to link it ultimately to the controller. The cable (500) is integrated into the moving structure of the coordinate measurement machine (100). The cables are preferably arranged in drag chains for protection and optimal durability. As a result, the cables are specified for use inside a drag chain, wherein parameters such as bend radius, number of bends, outer diameter, and internal wire arrangement depend on the functionality of the probe head (112). The measurement probe (110) that is installed onto the probe head (112) preferably uses a high electronic bandwidth to transfer its signal from the probe sensor to the sensor controller.

There are different types of probe heads (112) available with differing functionality, such as fixed, manually rotatable, motor driven (continuous or indexed) around 1, 2 or 3 rotation axes. FIG. 10A-C illustrates some differing probe heads (112). A connection between the probe head (112) and the controller may require different types and configurations of wires to be used (coaxial, twisted pair, optical fibre). In certain cases (e.g. laser scanning sensor) a matching wiring type is required in order to guarantee a sufficient transfer bandwidth. Changing the type of probe head (112) on an existing coordinate measurement machine may require replacement of the cable between the controller and the probe head (112) with another, matching type of cable.

The selection of the type of probe head (112) is not always known at the time of construction of the coordinate measurement machine (100). Having to change the cabling of the coordinate measurement machine (100) is a costly intervention that may have implications on the quality and durability of the coordinate measurement machine cabling over the course of its life cycle. Furthermore, the user of the coordinate measurement machine (100) may want to upgrade the coordinate measurement machine (100) to be able to attach another type of probe head (112) to obtain improved performance or extended functionality. Due to the nature of a typical coordinate measurement machine (100) (which often comprises a heavy granite table and is extremely sensitive to transport), such a change would have to be performed on the user's site, which would incur high costs of service.

The invention comprises a universal coordinate measurement machine cable (500), as shown, for instance, in FIG. 7A, as a single solution for the coordinate measurement machine probe head cabling that has the capability of matching all types of probe heads (112). The cable (500) is preferably integrated into the coordinate measurement machine (100) as part of the coordinate measurement machine (100) build. Upon the installation of a specific probe head (112), the connection between the universal coordinate measurement machine cable (500) and the probe head (112) is performed by a connection of the cable (500) to the probe head (112), optionally via an adapter (600), also known herein as a first adapter.

With the universal coordinate measurement machine cable (500) installed, the coordinate measurement machine (100) no longer needs to be dismantled to replace the cable (500) in order to be able to fit another type of probe head (112).

In some preferred embodiments according to the fourth aspect of the invention, the co-ordinate measurement machine (100) is provided with a multipurpose electrical and/or data connection cable (500) for connecting a probe head (112) to a controller unit (132) disposed apart from the co-ordinate measurement machine (100); the connection cable (500) comprising:
a cable component (510) comprising:
   a co-axial cable (512);
   a twisted pair cable (514);
   optionally, a fibre optic cable; and
   optionally, a multi-strand cable and/or a single-strand cable (516);
preferably, a first connector unit (530) comprising one or more connectors (532) for connecting one or more, preferably all of the cables within the cable component (510) to the probe head (112), optionally via an adapter (600); and
preferably, a first coupling unit (540) for dismountably attaching the first connector unit (530) to the probe head (112) or to the adapter (600).

In a fifth aspect, the invention provides a co-ordinate measurement machine (100) comprising a multipurpose electrical and/or data connection cable (500); the connection cable (500) comprising:
a cable component (510) comprising:
   a co-axial cable (512);
   a twisted pair cable (514);
   optionally, a fibre optic cable; and
   optionally, a multi-strand cable and/or a single-strand cable (516);
a first connector unit (530) comprising one or more connectors (532) for connecting one or more, preferably all of the cables within the cable component (510) to the probe head (112), optionally via an adapter (600); and
a first coupling unit (540) for dismountably attaching the first connector unit (530) to the probe head (112) or to the adapter (600).

In a sixth aspect, the invention provides a multipurpose electrical and/or data connection cable (500) for a co-ordinate measurement machine (100), preferably for a co-ordinate measurement machine (100) as described above; the connection cable (500) comprising:
a cable component (510) comprising:
   a co-axial cable (512);
   a twisted pair cable (514);
   optionally, a fibre optic cable; and
   optionally, a multi-strand cable and/or a single-strand cable (516);
preferably, a first connector unit (530) comprising one or more connectors (532) for connecting one or more, preferably all of the cables within the cable component (510) to the probe head (112), optionally via an adapter (600); and
preferably, a first coupling unit (540) for dismountably attaching the first connector unit (530) to the probe head (112) or to the adapter (600).

In some embodiments, the cable component (510) comprises a fibre optic cable. In some embodiments, the cable component (510) comprises a a multi-strand cable. In some embodiments, the cable component (510) comprises a single-strand cable (516). In some embodiments, the first connector unit (530) comprises one or more connectors (532) for connecting one or more of the cables within the cable component (510) to the probe head (112) via an adapter (600).

In these aspects of the invention, the connection cable (500) may further comprise:
a second connector unit (530′) comprising one or more connectors (532′) for connecting one or more of the cables within the cable component (510) to a controller (132), optionally via a second adapter (600′), and
preferably, a second coupling unit (540′) for dismountably attaching the second connector unit (530′) to the controller (112) or to the second adapter (600′),

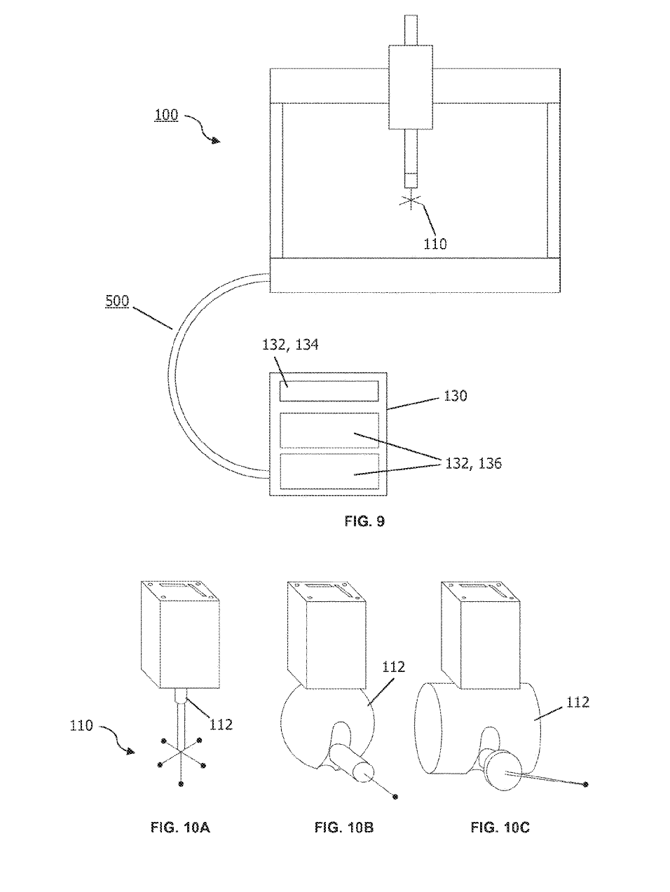

FIG. 9 illustrates a coordinate measurement machine (100) comprising a measurement probe (110), connected through a connection cable (500) to a coordinate measurement machine controller cabinet (130) comprising a multi-element controller unit (132); the controller unit (132) comprises a probe head controller (136) and a coordinate measurement machine controller (138). As used herein, the terms “cable” and “wire” are used interchangeably.

The cable component (510) between the probe head and the probe head controller is disposed at least partly, preferably entirely inside the coordinate measurement machine (100) for optimal protection and for durability. Due to the nature of the coordinate measurement machine (100) as a measurement instrument, the cable component (510) is preferably thin, light and flexible in order to avoid any degradation of the measurement accuracy. High stresses in the cable component (510) due to the cable bending may be transposed onto the moving structure of the coordinate measurement machine (100) and therefore cause the cable component (510) to affect the coordinate measurement machine's motion. The integration of multiple cables is therefore preferably avoided.

The cable component (510) comprises a plurality of individual cables, which may be electrical and/or optical cables. In order to support the high bandwidth transfer functionality of the probe heads (112), the cable component (510) preferably comprises:
one or more co-axial cables (512); and
one or more twisted pair cable (514).

For a coordinate measurement machine (100) that is equipped with a coax based probe head type, the co-axial cable (512) inside the cable component (510) may be used for the data transfer signals. For a coordinate measurement machine (100) that is equipped with a twisted pair based probe head type for data transfer, the one or more twisted pair cable (514) of the cable component (500) be used.

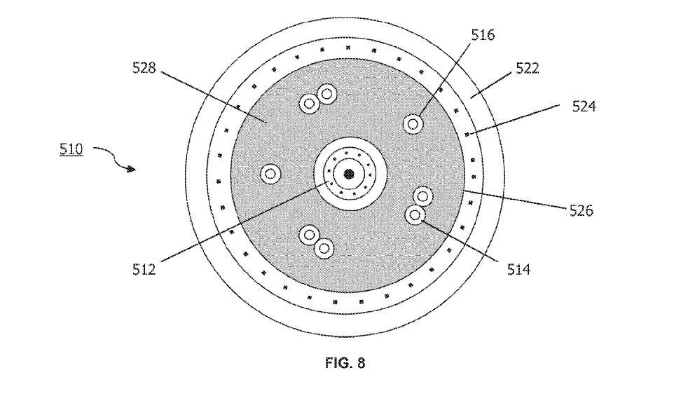

In some embodiments, the cable component (510) has an essentially round cross section, preferably with an outer diameter of at least 6 mm and at most 16 mm, for example of at least 8 mm and at most 14 mm, for example of at least 10 mm and at most 12 mm. In some embodiments, the cable component (510) has an essentially rectangular cross section, for example the cable component (510) is a flat cable. Other cross-sections are also possible for the present invention. As shown in FIG. 8, the cable component (510) may comprise one or more of the following parts:
a coaxial wire (512), preferably with an outer diameter of at least 1 mm and at most 6 mm, preferably of at least 2 mm and at most 5 mm, for example of at least 3 mm and at most 4 mm, possibly arranged in the centre of the cable component (510);
one or more sets of twisted pair wires (514);
optionally, one or more single-strand wires or optical fibres (516);
filling material (528), configured to maintain the position of the components of the cable during bending;
an electromagnetic shielding layer, possibly comprised of a plated copper braid (524) and/or a shielding foil (526);
an outer sheath (522), preferably configured to provide sufficient support to keep the wire arrangement in place, preferably configured to provide a pre-determined minimal bending radius, and preferably configured to guarantee the required durability according to the specified number of bends.

The outer sheath (522) may comprise labelling to identify the cable and show electrical compliance regulation. The cable component (510) may comprise continuous lengths of individual cables i.e. without interruption. Alternatively, the cable component may comprise two or more section, connected by inline connectors. The use of sections of cables may enable simpler assembly of a coordinate measurement machine during the assembly process.

Preferably, one end of the cable (500) is disposed with a first connector unit (530) comprising one or more connectors (532) for connecting the one or more of the cables within the cable component (510) to the probe head (112), optionally via an adapter (600). The first connector unit (530) is disposed with a plurality of individual connectors (532) that connect with reciprocating connectors on the first adapter (600) or on the probe head (112), for the transfer of signals and/or electrical power. For the transfer of electrical signals and electrical power, the connectors (532) may comprise conductive compliant members. For the transfer of optical signals, the connector (532) may comprise one part of a male/female connection. The first connector unit (530) may be formed in the most part from a printed circuit board (PCB).

Preferably, the same end of the cable (500) is provided with a first coupling (540) for dismountably attaching the first connector unit (530) to the probe head (112) or to the adapter (600). The first coupling (540) is a mechanical coupling for the dismountable attachment of the cable (500) to the first adapter (600), or to the probe head (112). As such, the coupling may comprise a screw fitting, a snap fitting, or other such temporary attachment fittings, to support the weight of the probe, probe head, and optional adapter. The first connector unit (530) may be rigidly attached to the first coupling (540).

Preferably, the other end of the cable (500) is disposed with a second connector unit (530′) comprising one or more connectors (532′) for connecting the one or more of the cables within the cable component (510) to the controller (132), optionally via a second adapter (600′). The second connector unit (530′) is disposed with a plurality of individual connectors (532′) that connect with reciprocating connectors on the second adapter (600′) or on the controller (132), for the transfer of signals and/or electrical power. For the transfer of electrical signals and electrical power, the connectors (532′) may comprise conductive compliant members. For the transfer of optical signals, the connector (532′) may comprise one part of a male/female connection. The second connector unit (530′) may be formed in the most part from a printed circuit board (PCB).

Preferably, the same end of the cable (500) is provided with a second coupling (540′) for dismountably attaching the second connector unit (530′) to the controller (132) or to the second adapter (600′). The second coupling (540′) is a mechanical coupling for the dismountable attachment of the cable (500) to the second adapter (600′), or to the controller (132). As such, the coupling may comprise a screw fitting, a snap fitting, or other such temporary attachment fittings. The second connector unit (530′) may be rigidly attached to the second coupling (540′).

FIG. 7A illustrates a connection cable (500) comprising a component (510), having a first connector unit (530) at one end and a second connector unit (530′) at the other end. The first and second connector units (530, 520′) may be directly connected to the probe head (112) or controller (132) respectively, or can be connected via an adapter (600, 600′), specifically a first adapter (600) or a second adapter (600′).

The first adapter (600) may comprise a cable-side connector unit (644) and cable-side coupling (642) for dismountable attachment to the cable (500) at one end, and a probe-side connector unit (646) and probe-side coupling (648) for dismountable attachment to the probe head (112) at the other end of the cable (500).

The first adapter (600) cable-side connector unit (644) is disposed with individual connectors (632) that connect with reciprocating connectors (532) on the cable (500), for the transfer of signals and/or electrical power. Similarly, the first adapter (600) probe-side connector unit (646) is disposed with individual connectors (634) that connect with reciprocating connectors (532) on the probe head (114), for the transfer of signals and/or electrical power. For the transfer of electrical signals and electrical power, the connectors (632, 634) may comprise conductive compliant members. For the transfer of optical signals, the connectors (632, 634) may comprise one part of a male/female connection. The connector unit (644, 646) may be formed in the most part from a printed circuit board (PCB).

The first adapter (600) cable-side coupling (642) is a mechanical coupling for the dismountable attachment of the first adapter (600) to the cable (500). The probe-side coupling (648) is a mechanical coupling for the dismountable attachment of the first adapter (600) to the probe head (112). As such, the coupling may comprise a screw fitting, a snap fitting, or other such temporary attachment fittings.

It is appreciated that a plurality of different first adapters (600) may be available, each having a different configuration of probe head (112) connector (646) and coupling (648), to match a particular probe head (112). In some embodiments, a plurality of different first adapters (600) emanate from the connection cable (500), so that the connection cable (500) is terminated by a plurality of different first adapters (600). An example of an alternative first adapter (600) is shown in FIG. 7B.

The second adapter (600′) may comprise a cable-side connector unit (644′) and cable-side coupling (642′) for dismountable attachment to the cable (500) at one end, and a controller-side connector unit (646′) and controller-side coupling (648′) for dismountable attachment to the controller (132) at the other end of the cable (500).

The second adapter (600′) cable-side connector unit (644′) is disposed with individual connectors (632′) that connect with reciprocating connectors (532′) on the cable (500), for the transfer of signals and/or electrical power. Similarly, the second adapter (600′) controller-side connector unit (646′) is disposed with individual connectors (634′) that connect with reciprocating connectors (134) on the controller (132), for the transfer of signals and/or electrical power. For the transfer of electrical signals and electrical power, the connectors (632′, 634′) may comprise conductive compliant members. For the transfer of optical signals, the connectors (632′, 634′) may comprise one part of a male/female connection. The connector unit (644′, 646′) may be formed in the most part from a printed circuit board (PCB).

The second adapter (600′) cable-side coupling (642′) is a mechanical coupling for the dismountable attachment of the first adapter (600) to the cable (500). The controller-side coupling (648′) is a mechanical coupling for the dismountable attachment of the second adapter (600) to the controller (132). As such, the coupling may comprise a screw fitting, a snap fitting, or other such temporary attachment fittings.

It is appreciated that a plurality of different second adapters (600′) may be available, each having a different configuration of controller-side connector (646′) and coupling (648′), to match a particular controller (132). In some embodiments, a plurality of different second adapters (600′) emanate from the connection cable (500), so that the connection cable (500) is terminated by a plurality of different second adapters (600′). An example of an alternative second adapter (600′) is shown in FIG. 7B.

The connection cable (500) of the present invention has the advantages that it does not introduce excessive stress into the structure, which may cause it to bend and measure inaccurately. Furthermore, the minimal bend radius is low, even when using components such as coax wire and optical fibre. The connection cable (500) features sufficient wire connections to cope with all applications. The outer diameter is low in order to support the small bend radius and to provide longer product durability. In some embodiments, in order to avoid “ringing” at the high frequency data transfer rates, the connectors (530) have an impedance matching on the coaxial (512) and twisted pair wires (514), preferably wherein the impedance is at least 50 Ohm and at most 100 Ohm, for example of about 75 Ohm.

Cables that are fed through drag chains tend to bend sideways, show friction with the other cables in the chain and show early wear due to the friction and bending. The present cable design should avoid excessive friction in the drag chain.

1. A method for creating or refining a mathematical correction model for correcting measurement errors in a co-ordinate measurement machine (100) having at least 3 linear machine axes X, Y, and Z (102, 104, 106), each comprising a machine linear scale (102′, 104′, 106′), and provided with a measurement probe (110), the method comprising accelerating the measurement probe (110) and at least one of the 3 linear machine axes X, Y, and Z (102, 104, 106) of the co-ordinate measurement machine (100) along one of the linear machine axes X, Y, and Z (102, 104, 106), and creating or refining the mathematical correction model using an apparent measurement probe (110) position, actual measurement probe (110) position, and coordinate measurement machine (100) acceleration at said apparent and actual positions; and wherein the mathematical correction model comprises a correction term for an offset for one or more of the machine linear scales (102′, 104′, 106′), which offset is defined as a distance between the measurement probe (110) and the respective machine linear scale (102′, 104′, 106′).

2. The method according to claim 1 wherein the offset for each of the machine linear scales (102′, 104′, 106′) is calculated from read-off points roX, roY and roZ on each of the machine linear scales (102′, 104′, 106′).

3. The method according to claim 1, wherein the mathematical correction model comprises a correction term for the measurement along the X-axis (102), wherein the correction term is dependent on the acceleration of the measurement probe (110) along the X-axis (102) as measured on the read-off point roX on the machine linear scale along the X-axis (102′), and dependent on the Y-position and Z-position of the measurement probe (110) as measured on read-off points roY and roZ respectively on the machine linear scales along the Y-axis and Z-axis (104′, 106′); and/or wherein the mathematical correction model comprises a correction term for the measurement along the Y-axis (104), wherein the correction term is dependent on the acceleration of the measurement probe (110) along the Y-axis (104) as measured on the read-off point ROY on the machine linear scale along the Y-axis (104′), and dependent on the Z-position of the measurement probe (110) as measured on the read-off point roZ on the machine linear scale along the Z-axis (106′).

4. The method according to claim 1, comprising the steps:
(i) accelerating the measurement probe (110) and at least one of the 3 linear machine axes X, Y, and Z (102, 104, 106) of the co-ordinate measurement machine (100) along one of the linear machine axes (102, 104, 106);
(ii) measuring the apparent position of the measurement probe (110) using the machine linear scale (102′, 104′, 106′) and synchronously measuring the actual position of the measurement probe (110);
(iii) calculating measurement errors as a function of co-ordinate measurement machine (100) acceleration and apparent and actual measurement probe (110) positions;
(iv) repeating steps (i) to (iii) for different measurement probe (110) positions and/or co-ordinate measurement machine (100) accelerations, and
(v) creating or refining a mathematical correction model using the measurement errors at different measurement probe (110) positions and co-ordinate measurement machine (100) accelerations.

5. The method according to claim 1, wherein the actual position of the measurement probe (110) is determined using a dynamic laser measurement, preferably using a laser interferometer or a laser distance sensor.

6. The method according to claim 1, wherein the apparent measurement probe (110) position is determined from the machine linear scale (102′, 104′, 106′).

7. The method according to claim 1, wherein the co-ordinate measurement machine (100) acceleration is determined from the machine linear scale (102′, 104′, 106′).

8. The method according to claim 1, performed without using a reference object.

9. The method according to claim 1, wherein the mathematical correction model further utilises one or more mechanical properties of the co-ordinate measurement machine (100), or parts thereof, and/or the centre of mass of the co-ordinate measurement machine (100), or parts thereof.

10. A method for the dimensional measurement of an object (200) using a co-ordinate measurement machine (100) provided with a measurement probe (110), which coordinate measurement machine (100) is configured to output positions of the measurement probe (110) from which an acceleration of measurement probe (110) and one or more of the 3 linear machine axes X, Y, and Z (102, 104, 106) of the co-ordinate measurement machine (100), and an apparent dimensional measurement of the object (200) can be calculated, the method comprising the steps of:
(a) moving the measurement probe (110) and one or more of the 3 linear machine axes X, Y, and Z (102, 104, 106) of the co-ordinate measurement machine (100), to obtain an apparent dimensional measurement of the object (200);
(b) calculating the acceleration of the measurement probe (110) and one or more of the 3 linear machine axes X, Y, and Z (102, 104, 106) of the coordinate measurement machine (100);
(c) providing a mathematical correction model for predicting a measurement error for a measurement probe (110) moved to a position at a co-ordinate measurement machine (100) acceleration, for example depending on general input variables position (P) and acceleration (A);
(d) applying the mathematical correction model to obtain a measurement error for the apparent measurement of the object (200) obtained by moving the co-ordinate measurement machine (100) at the acceleration; and
(e) correcting the apparent measurement of the object (200) with the measurement error to obtain a corrected measurement of the object (200).

11. The method according to claim 10, wherein the mathematical correction model provided in step (c) was created or refined with a method for creating or refining a mathematical correction model for correcting measurement errors in a co-ordinate measurement machine (100) having at least 3 linear machine axes X, Y, and Z (102, 104, 106), each comprising a machine linear scale (102′, 104′, 106′), and provided with a measurement probe (110), the method comprising accelerating the measurement probe (110) and at least one of the 3 linear machine axes X, Y, and Z (102, 104, 106) of the co-ordinate measurement machine (100) along one of the linear machine axes X, Y, and Z (102, 104, 106), and creating or refining the mathematical correction model using an apparent measurement probe (110) position, actual measurement probe (110) position, and coordinate measurement machine (100) acceleration at said apparent and actual positions; wherein the mathematical correction model comprises a correction term for an offset for one or more of the machine linear scales (102′, 104′, 106′), which offset is defined as a distance between the measurement probe (110) and the respective machine linear scale (102′, 104′, 106′); and wherein the offset for each of the machine linear scales (102′, 104′, 106′) is calculated from read-off points roX, roY and roZ on each of the machine linear scales (102′, 104′, 106′).

12. A computer program, or a computer program product directly loadable into the internal memory of a computer, or a computer program product stored on a computer readable medium, or a combination of such computer programs or computer program products, configured for creating or refining a mathematical correction model for a co-ordinate measurement machine (100) according to claim 1, or configured to perform a dimensional measurement of an object (200) using a co-ordinate measurement machine (100).

13. A system (1) comprising a co-ordinate measurement machine (100) provided with a measurement probe (110), and a computer (400) comprising the computer program, or the computer program product, according to claim 12.

14. The system according to claim 13, wherein the co-ordinate measurement machine (100) is provided with a multipurpose electrical and/or data connection cable (500) for connecting the probe head (112) to a controller unit (132) disposed apart from the co-ordinate measurement machine (100); the connection cable (500) comprising:
a cable component (510) comprising:
a co-axial cable (512);
a twisted pair cable (514);
a first connector unit (530) comprising one or more connectors (532) for connecting one or more of the cables within the cable component (510) to the probe head (112); and
a first coupling unit (540) for dismountably attaching the first connector unit (530) to the probe head (112) or to the adapter (600).

15. A co-ordinate measurement machine (100) comprising a multipurpose electrical and/or data connection cable (500) for connecting a probe head (112) to a controller unit (132) disposed apart from the co-ordinate measurement machine (100) comprising:
a cable component (510) comprising:
a co-axial cable (512);
a twisted pair cable (514);
a first connector unit (530) comprising one or more connectors (532) for connecting one or more of the cables within the cable component (510) to the probe head (112); and
a first coupling unit (540) for dismountably attaching the first connector unit (530) to the probe head (112) or to the adapter (600).

16. The system according to claim 14, or the co-ordinate measurement machine (100), wherein the cable component (510) comprises a fibre optic cable.

17. The system according to claim 14, or the co-ordinate measurement machine (100) wherein the cable component (510) comprises a multi-strand cable.

18. The system according to claim 14, or the co-ordinate measurement machine (100), wherein the cable component (510) comprises a single-strand cable (516).

19. The system according to claim 14, or the co-ordinate measurement machine (100), wherein the first connector unit (530) comprises one or more connectors (532) for connecting one or more of the cables within the cable component (510) to the probe head (112) via an adapter (600).
